(19) United States
(12) Patent Application Publication
(10) Pub. No.: US 2011/0300382 A1
(43) Pub. Date: Dec. 8, 2011

(54) Fibers and Nonwovens Made from uncross-linked alkyd oligomers

(76) Inventors: Isao Noda, Fairfield, OH (US); William Maxwell Allen, Liberty, OH (US)

(21) Appl. No.: 13/152,876

(22) Filed: Jun. 3, 2011

Related U.S. Application Data
(60) Provisional application No. 61/351,166, filed on Jun. 3, 2010.

(51) Int. Cl. D02G 3/00; B29C 47/78

(52) U.S. Cl. 428/401; 264/639

(57) ABSTRACT

Disclosed herein are articles produced from the vitrification of uncross-linked alkyd oligomers. The articles include fibers, nonwovens, and articles made from nonwovens such as, for example, diapers, wipes, feminine hygiene articles, drapes, gowns, sheeting, and bandages. Also disclosed herein is a method for making articles composed of uncross-linked alkyd oligomers.

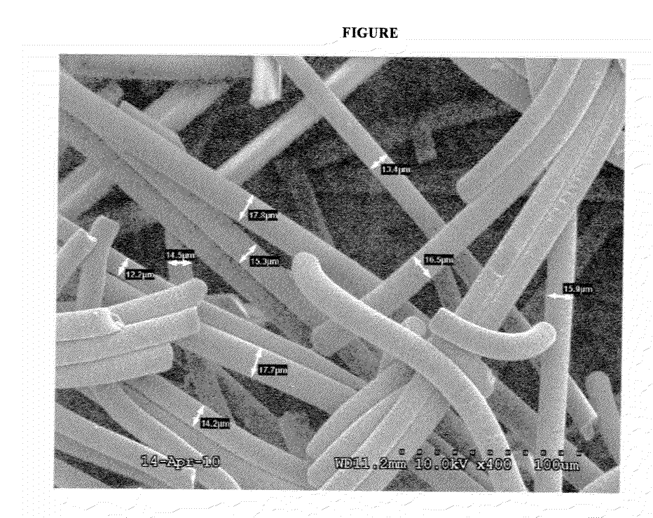

### CROSS REFERENCE TO RELATED APPLICATION

This application claims the benefit of U.S. Provisional Application No. 61/351,166 filed Jun. 3, 2010.

### FIELD OF THE INVENTION

The disclosure generally relates to articles produced from uncross-linked alkyd oligomers. More specifically, the disclosure relates to fibers formed from the vitrification of uncross-linked alkyd oligomers, methods of forming these fibers, and nonwoven articles made from these fibers.

### BACKGROUND OF THE INVENTION

Nonwoven articles can be manufactured from synthetic fibers that are composed of essentially three different classes of materials: thermoplastic resins, thermoset resins, and cross-linked alkyd resins. Nonwoven articles are most commonly made from fibers composed of thermoplastic resins. Thermoplastic resins, such as, for example, nylon, polystyrene, poly(methyl methacrylate), poly(ethylene terephthalate), and polytrifluorochloroethylene, are high molecular weight polymers that melt into soft, pliable material when heated, and freeze to a hard, crystalline or glassy state when cooled. Thermoplastic resins can undergo this melt processing repeatedly, allowing them to be recycled or remolded into different shapes. Thermoplastic resins are soluble in certain solvents, such as, for example, ortho-chlorophenol, mineral oil, and benzene. Although thermoplastic fibers have good mechanical properties, such as, for example, strength and recyclability, the inherent properties of thermoplastics make these fibers very difficult to process.

During fiber formation, the high molecular weight thermoplastics are heated to result in a melt with a very high viscosity. For example, the typical viscosity range of a thermoplastic melt is about 300 kg m⁻¹ s⁻¹ to about 2000 kg m⁻¹ s⁻¹, when measured at a shear rate of less than 10 s⁻¹. This melt is subsequently spun into fiber. To spin the melt, special equipment that is capable of pumping and conveying very viscous material (e.g., a high-powered extruder) is required. Also, the spinning must be operated at very high temperatures to allow the viscous melt to flow. Further, the high viscosity melt of thermoplastic resins limits the properties of the resulting fibers. For example superfine fibers (i.e. fibers having a diameter of less than about 10 μm), which must be produced from a low viscosity melt (e.g., much less than about 200 kg m⁻¹ s⁻¹, often even below 10 kg m⁻¹ s⁻¹), cannot be processed using traditional thermoplastic materials unless they are heated to a very high temperature (e.g., more than 100° C. above the melt temperature). Forming a low viscosity melt from thermoplastics would necessitate such high temperatures that the thermoplastic polymer itself may undergo thermal decomposition. Further still, conventional thermoplastic resins are typically derived from high-cost petroleum-based feedstock.

Nonwoven articles have less traditionally been manufactured from synthetic fibers composed of thermoset resins. Thermoset resins, such as, for example, phenol, formaldehyde, urea formaldehyde, and epoxy, are high molecular weight polymers that irreversibly convert into infusible and insoluble polymer networks by curing. Curing refers to the toughening or hardening of a polymer material by the cross-linking of polymer chains. Cross-linking is the process of bonding one polymer chain to another. Prior to curing, thermoset materials are typically liquid or malleable, and exist as a reactive mixture of monomers and oligomers that can be spun into fibers. Compared with thermoplastics, fibers made from thermoset resins have superior dimensional stability and both thermal and chemical resistance. Unlike thermoplastic resins, fibers made from thermoset resins cannot be reprocessed or recycled. Other disadvantages of fibers made from thermoset resins include the release of undesirable and often toxic fumes during processing, minimal control of solidification during fiber formation, and the high cost associated with petroleum feedstock.

Recently, nonwoven articles have been manufactured from fibers composed of cross-linked alkyd resins. Alkyd resins are polymer networks having ester cross-links that are formed by the condensation of polyols with polyfunctional acids, anhydrides, or a mixture of polyfunctional acids and anhydrides. Upon curing, alkyd resins exhibit properties characteristic of thermoset resins. Fibers comprised of cross-linked alkyd resins have the advantages of high surface energy and wettability, unlike fibers comprised of conventional thermoplastics such as, for example, polyolefin, and are environmentally degradable and chemically recyclable. Further, cross-linked alkyd resins can be spun into superfine fibers. However, the formation of cross-linked alkyd resin fibers requires processing at high temperatures and an extra cross-linking step, both of which can be undesirable.

### SUMMARY OF THE INVENTION

Disclosed herein are articles comprised of fibers that are made from the vitrification of uncross-linked alkyd oligomers. The uncross-linked alkyd oligomers, when liquefied, have a viscosity of about 0.1 kg m⁻¹ s⁻¹ to about 20 kg m⁻¹ s⁻¹. The fibers are substantially free of water. have an equivalent diameter that is less than about 200 μm, and a lengthwise dimension that is at least about 20 times the equivalent diameter. The fibers optionally comprise one or more additives such as, for example, polymers, surfactants, plasticizers, colorants, dyes, pigments, and mixtures thereof. The articles can include nonwovens and articles made from nonwovens such as, for example, diapers, wipes, feminine hygiene products, drapes, gowns, sheeting, and bandages.

Yet another aspect of the invention is a method of producing uncross-linked alkyd oligomer fibers. In this method, uncross-linked alkyd oligomers are liquefied through heating to forma melt with a viscosity of about 0.1 kg m⁻¹ s⁻¹ to about 20 kg m⁻¹ s⁻¹. The melt undergoes pumping and spinning through a die, without inducing cross-linking, to form molten fibers. Finally, the molten fibers are vitrified, typically by cooling, without inducing cross-linking.

Additional features of the invention may become apparent to those skilled in the art from a review of the following detailed description, taken in conjunction with the drawing, the examples, and the appended claims.

### BRIEF DESCRIPTION OF THE DRAWINGS

The sole FIGURE is an image of fibers comprised of uncross-linked alkyd oligomers that was taken with a scanning electron microscope. The image shows fibers that have equivalent diameters in the range of about 10 μm to about 20 μm.

### DETAILED DESCRIPTION OF THE INVENTION

It has now been found that fibers can be formed through the vitrification of low molecular weight, uncross-linked alkyd oligomers. These water-stable fibers have surprisingly small diameters, which allow the production of products with high opacity, flexibility, good fluid handling capacity, softness, and strength. Further, the fibers of the invention can be processed without a high energy conveying device (e.g., an extruder), at moderate temperatures, and without an additional cross-linking step.

Many low molecular weight materials are not capable of producing high quality fibers, or even any fibers at all. For example, molten wax is low molecular weight but cannot be spun into fibers. During fiber spinning, the polymers in the melt must interact with each other to keep from breaking apart into droplets. Many low molecular weight materials cannot be used to form fibers because they do not meet the viscosity and cohesion requirements needed to prevent droplet formation. Although some low molecular weight materials (e.g., sucrose) can be spun into fibers due to the presence of strong hydrogen bonding interactions, the resulting fibers tend to be very hygroscopic and water soluble. Thus, it is quite unexpected and surprising that fibers with good mechanical properties, such as, for example, strength, can be formed from low molecular weight, uncross-linked alkyd oligomers.

The fibers of the invention are possible because of the unique chemical structure of alkyd oligomers, which are low molecular weight materials that have ester bonds. As used herein, an “alkyd oligomer” is a compound that results from the condensation of a polyol with polyfunctional acids, anhydrides, or a mixture of polyfunctional acids and anhydrides to form a product with up to about 10, preferably up to about 7, more preferably up to about 5 (e.g., about 4) monomer units and/or a molecular weight of less than about 3000 g/mol, preferably less than about 2000 g/mol, more preferably less than about 1000 g/mol. Because alkyd oligomers are of low molecular weight, they can be liquefied into low viscosity melts (e.g., less than about 20 kg m⁻¹ s⁻¹). An alkyd oligomer “melt” is formed by heating alkyd oligomers until a liquid state occurs. This low viscosity melt is then spun into fibers. Without intending to be bound by any particular theory, it is believed that alkyd oligomers inherently have enough hydrogen bonding to provide sufficient integrity in the melt during spinning, while forming products that are water stable.

Low viscosity melts allow fibers to be spun using less demanding processing conditions than spinning fibers from high viscosity melts. Unlike conventional thermoplastics, for example, fibers can be spun from uncross-linked alkyd oligomers at relatively low temperatures (e.g., less than 200° C.) through a simple spinneret, without the aid of an extruder. Further, the low viscosity of the melt allows easy addition of additives before spinning, without relying on a compounding extruder. Further still, this low viscosity melt enables the production of fibers with extremely small diameters (i.e. superfine fibers), leading to materials having high opacity, flexibility, good fluid handling capacity, softness, and strength. In contrast, typical polar polymers, such as, for example, polyesters (e.g., the fibers disclosed in U.S. Pat. No. 6,562,938) and polyamides, are quite difficult to form into superfine fibers due to their high melt temperatures and high viscosity (e.g., greater than 300 kg m⁻¹ s⁻¹ measured at the shear rate of 10 s⁻¹ or less) of their melts. Other advantageous properties of uncross-linked alkyd oligomer fibers include high surface energy and wettability and the ability to tailor the properties of the fibers by altering the composition of the alkyd oligomer used and by incorporating additives into the melt. Further, the fibers of the invention are more ductile and deformable than fibers formed from cross-linked alkyd resins. Further still, uncross-linked alkyd oligomer fibers are comprised of biorenewable materials, which provide promising alternatives to petroleum-based feedstock, are expected to be environmentally degradable by spontaneous hydrolysis or biodegradation, and recyclable using acid- or base-catalyzed chemical digestion.

In one aspect, the invention relates to an article comprising a fiber made from uncross-linked alkyd oligomers. As used herein, a “fiber” is a slender and greatly elongated material with an equivalent diameter that is less than about 200 μm and a lengthwise dimension that is at least 20 times the equivalent diameter. Typically, the lengthwise dimension of the fiber is at least 200 times the equivalent diameter, preferably at least 2000 times the equivalent diameter, and more preferably at least 20,000 times the equivalent diameter, with no upper limit. In some embodiments, the equivalent diameter of the fiber is less than about 150 μm, less than about 100 μm, less than about 50 μm, or less than about 30 μm. In other embodiments, the equivalent diameter of the fiber is about 0.1 μm to about 30 μm, preferably about 0.2 μm to about 15 μm, and more preferably about 5 μm to about 14 μm. As used herein, “equivalent diameter” is defined as four times the area of the cross-section of the fiber divided by its perimeter. For example, a fiber that has across-section in the shape of a circle and a diameter of 200 μm has an equivalent diameter of 200 μm. It is noted that other embodiments of the invention may employ fibers having equivalent diameters as defined in Table 5-8 of PERRY'S CHEMICAL ENGINEERS' HANDBOOK, 5-25 (6th ed. 1984) (see also, 7th ed. 1997 at 6-12 to 6-13). For example, a fiber that has across-section in the shape of a rectangle with sides that are 200 μm and 150 μm in length has an equivalent diameter of four times (200×150)/[2(200+150)], or about 171.4 μm. The equivalent diameter of the fiber is controlled by factors well-known in the fiber spinning art including, for example, spinning speed and mass through-put.

The fiber of this aspect of the invention is composed of uncross-linked alkyd oligomer. The alkyd oligomer has a molecular weight of no more than 3000 g/mol, preferably no more than 2000 g/mol, more preferably no more than 1000 g/mol; and no more than 10 repeating units, preferably no more than 7 repeating units, more preferably no more than 5 repeating units, for example, 4 repeating units. When liquefied, the alkyd oligomer has a viscosity of about 0.1 kg m⁻¹ s⁻¹ to about 20 kg m⁻¹ s⁻¹, preferably about 0.5 kg m⁻¹ s⁻¹ to about 10 kg m⁻¹ s⁻¹, more preferably about 1 kg m⁻¹ s⁻¹ to about 5 kg m⁻¹ s⁻¹. The alkyd oligomers are uncross-linked and nonreactive and do not contain an amount of functional groups that can cause cross-linking by free radical addition chemistry (i.e. no more than 5% of carbon-carbon bonds are alkynes and/or alkenes). In some embodiments, the fiber is substantially free of water. As used herein, “substantially free of water” refers to a fiber with less than about 2 wt. % (e.g., less than about 1 wt. %, less than about 0.5 wt. %, less than about 0.1 wt. %. 0 wt. %) of water, based on the total weight of the fiber. As used herein, “nonreactive” refers to an alkyd oligomer that neither chemically reacts nor requires chemical reaction during fiber formation. For example, nonreactive alkyd oligomers for use in accordance with the invention undergo no chemical reaction (other than perhaps some incidental reactions, such as minor oxidation) when exposed to the processing temperatures herein contemplated for fiber formation. Furthermore, nonreactive is used herein to denote that the alkyd oligomers experience no appreciable cross-linking when exposed to the processing temperatures herein contemplated during fiber formation.

The uncross-linked alkyd oligomers are formed by the condensation of polyols with an excipient selected from the group consisting of polyfunctional acids, anhydrides, and a mixture of polyfunctional acids and anhydrides. When the excipient is a polyfunctional acid, the molar ratio of total acid moieties on the polyfunctional acid to alcohol moieties on the polyol is about 10:1 to about 1:10, more preferably about 3:1 to about 1:3, and even more preferably about 1:1. When the excipient is an anhydride, the molar ratio of total anhydride moieties on the anhydride to total alcohol moieties on the polyol is about 5:1 to about 1:5, preferably about 1.5:1 to about 1:1.5 even more preferably about 0.5:1.

The polyol preferably is a molecule that includes at least two alcohol moieties. Preferably, the alcohol moieites are primary hydroxyl groups. Nonlimiting examples of polyols include glycerol, 1,3-propanediol, pentaerythritol, dipentaerythritol, trimethylolpropane, trimethylolethane, ethylene glycol, diethylene glycol, propylene glycol, dipropylene glycol, polyglycerol, diglycerol, triglycerol, 1,2-propanediol, 1,4-butanediol, neopentylglycol, hexanediol, hexanetriol, glucose, sucrose, fructose, raffinose, maltodextrose, galactose, xylose, maltose, lactose, mannose, erythrose, pentaerythritol, erythritol, xylitol, malitol, mannitol, sorbital, polyvinyl alcohol, and mixtures thereof. In some specific embodiments, the polyol is selected from the group consisting of glycerol, pentaerythritol, trimethylolpropane, trimethylolethane, and mixtures thereof.

The excipient is selected from the group consisting of a polyfunctional acid, an anhydride, and mixtures thereof. The polyfunctional acid preferably is a molecule that includes at least two carboxylic acid moieties. The anhydride preferably is a molecule that includes at least one anhydride moiety. Nonlimiting examples of the excipient include adipic acid, maleic acid, fuamric acid, succinic acid, sebacic acid, citric acid, oxalic acid, malonic acid, suberic acid, fumaric acid, glutaric acid, phthalic acid, malonic acid, isophthalic acid, terephthalic acid, azelaic acid, dimer acid, dimethylolpropionic acid, maleic anhydride, succinic anhydride, phthalic anhydride, trimellitic anhydride, polyacrylic acid, polymethacrylic acid, and mixtures thereof. In some specific embodiments, the excipient is an anhydride selected from the group consisting of maleic anhydride, succinic anhydride, phthalic anhydride, and mixtures thereof. In a preferred embodiment, the excipient is phthalic anhydride.

In some embodiments, the uncross-linked alkyd oligomer further includes fatty acids, fats, oils (e.g., monoglycerides, diglycerides, triglycerides), or mixtures thereof. The incorporation of fatty acids, fats, oils, or mixtures thereof into the alkyd oligomers of the invention advantageously allows the mechanical properties of the resulting fibers, such as, for example, fineness and softness, to be tailored. For example, a higher concentration of a fatty acid, fat, oil, or mixtures thereof results in softer, more sustainable (compared to strictly petroleum-based products) fibers. “Fatty acid” refers to a straight chain monocarboxylic acid having a chain length of 12 to 30 carbon atoms. “Monoglycerides,” “diglycerides,” and “triglycerides” refer to mono-, di- and tri-esters, respectively, of (i) glycerol and (ii) the same or mixed fatty acids containing multiple unsaturated double bonds. Nonlimiting examples of fatty acids include oleic acid, myristoleic acid, palmitoleic acid, sapienic acid, linoleic acid, linolenic acid, arachidonic acid, eicosapentaenoic acid, and docosahexaenoic acid. Examples of fats include animal fat. Nonlimiting examples of monoglycerides include monoglycerides of any of the fatty acids described herein. Nonlimiting examples of diglycerides include diglycerides of any of the derivatized fatty acids described herein. Nonlimiting examples of the triglycerides include triglycerides of any of the fatty acids described herein. For example, the triglyceride can be selected from the group consisting of tall oil, corn oil, soybean oil, sunflower oil, safflower oil, linseed oil, perilla oil, cotton seed oil, tung oil, peanut oil, oiticica oil, hempseed oil, marine oil (e.g., alkali-refined fish oil), dehydrated castor oil, coconut oil, olive oil, palm seed oil, palm oil, rapeseed oil, whale oil, and mixtures thereof, In some embodiments, the triglyceride oil preferably is tall oil, corn oil, soybean oil, sunflower oil, safflower oil, perilla oil, cotton seed oil, peanut oil, oiticica oil, hempseed oil, marine oil (e.g., alkali-refined fish oil), dehydrated castor oil, or mixtures thereof.

In some embodiments, the alkyd oligomer can include up to about 80 wt. % fatty acid, fat, oil, or mixture thereof, based on the total weight of the oligomer. In some embodiments, the oligomer can include about 20 wt. % to about 40 wt. % fatty acid, fat, oil, or mixture thereof, based on the total weight of the oligomer. In other embodiments, the oligomer can include about 40 wt. % to about 60 wt. % fatty acid, fat, oil, or mixture thereof, based on the total weight of the oligomer. In still other embodiments, the oligomer can include about 60 wt. % to about 80 wt. % fatty acid, fat, oil, or mixture thereof, based on the total weight of the oligomer. The higher the concentration of a fatty acid, fat, oil, or mixtures thereof results in softer, more sustainable fibers. Adjusting the amount of fatty acid, fat, oil, or mixtures thereof to tailor the properties of the resulting fiber will be understood by those skilled in the art.

In some embodiments, the fiber comprises an additive that functions as a processing aid or affects the physical or mechanical properties of the resulting fiber. For example, the additive can affect the processing conditions of the fiber, its elasticity, tensile strength, modulus, oxidative stability, brightness, color, flexibility, resiliency, workability, odor control, or combinations thereof. The additive can be incorporated into the uncross-linked alkyd oligomer melt before spinning.

Polymers can be incorporated into the fiber as processing aids and/or to modify the end use of the fiber. For example, polyvinyl alcohol and polyhydric alcohols having molecular weights of greater than 2000 g/mol are typical additives. A small amount of thermoplastic polymers (e.g., less than about 5 wt. %, based on the total weight of the melt) such as, for example, polycaprolactone, poly(ethylene terephthalate), or mixtures thereof can function as additives to improve the spinnability of the uncross-linked alkyd oligomer melt. Water soluble synthetic polymers, such as, for example, polyacrylic acids, polyacrylic acid esters, polyvinylacetates, polyvinylalcohols, and polyvinylpyrrolidone, polyethylene oxide and polyethylene glycol are other examples of polymer additives.

Lubricant compounds can be incorporated into the uncross-linked alkyd oligomer melt to improve the flow properties of the melt during processing. The lubricant compounds can include animal or vegetable fats, preferably in their hydrogenated form, especially those which are solid at room temperature. Additional lubricant materials include monoglycerides (e.g., monostearate), diglycerides and phosphatides, especially lecithin.

Extender compounds, such as, for example, gelatin, vegetable proteins (e.g., sunflower protein), soybean proteins, cotton seed proteins, water soluble polysaccharides (e.g., alginates, carrageenans, guar gum, agar, alai arabic and related gums), pectin, water soluble derivatives of cellulose (e.g., alkylcelluloses, hydroxyalkylcelluloses, carboxymethylcellulose), can also function as additives.

Further additives include inorganic fillers such as, for example, the oxides of magnesium, aluminum, silicon, and titanium may be added as inexpensive fillers or processing aides. Other inorganic materials that can function as additives include hydrous magnesium silicate, titanium dioxide, calcium carbonate, clay, chalk, boron nitride, limestone, diatomaceous earth, mica glass quartz, and ceramics. Additionally, inorganic salts, including alkali metal salts, alkaline earth metal salts, phosphate salts, may be used as processing aides.

Stearate-based salts, which modify the water responsiveness of the fiber, are another example of additives. Examples of stearate-based salts include sodium, magnesium, calcium, and other stearates and rosin components including anchor gum rosin.

Additional examples of additives include antiblocking agents (e.g., magnesium stearate), slip agents (e.g., behenamide), viscosity modifiers, antioxidants, colorants, plasticizers, odor masking agents, emulsifiers, surfactants, cyclodextrins, optical brighteners, flame retardants, dyes, pigments, fillers, proteins and their alkali salts, waxes, tackifying resins, and any other processing aids or property modifiers used in the art, or combinations thereof.

The amount of the additive can be any amount conventionally used in the art. In some embodiments, less than about 50 wt. % of the additive is added to the uncross-linked alkyd oligomer melt, based on the total weight of the melt. Preferably, about 0.1 wt. % to about 20 wt. % of the additive is added to the melt, based on the total weight of the melt. More preferably, about 0.1 wt. % to about 12 wt. % of the additive is added to the melt, based on the total weight of the melt.

The fibers of the present invention may be used for any purposes for which fibers are conventionally used. This includes, without limitation, incorporation into nonwoven or woven webs and substrates. The fibers herein may be converted to nonwovens by any suitable methods known in the art. Continuous fibers can be formed into a web using industry standard spunbond type technologies, while staple fibers can be formed into a web using industry standard carding, airlaid, or wetlaid technologies. Typical bonding methods include: calendar (pressure and heat), thru-air heat, mechanical entanglement, hydrodynamic entanglement, needle punching, and chemical bonding and/or resin bonding. The calendar, thru-air heat, and chemical bonding are the preferred bonding methods for the ester condensate and polymer multicomponent fibers. Thermally bondable fibers are required for the pressurized heat and thru-air heat bonding methods.

The fibers of the present invention can include multiconstituent fibers in many different configurations. As used herein, “constituent” refers to the chemical species of matter or the material. For example, a multiconsitutent fiber may include different types of uncross-linked alkyd oligomers, synthesized from mixtures with different ratios of polyol, excipients, and fatty acids, fats, oils, or mixtures thereof. Likewise, the same uncross-linked alkyd oligomer mixed with different additives may also be the distinct constituents. Fibers may be of monocomponent or multicomponent in configuration. As used herein. “component” refers to a separate part of the fiber that has a spatial relationship to another part of the fiber.

Multiconstituent fibers include blends with other polymers such as, for example, natural and synthetic polymers and biodegradable and non biodegradable polymers. Nonlimiting examples of biodegradable thermoplastic polymers suitable for use in the present invention include aliphatic polyesteramides; diacid/diol aliphatic polyesters; modified aromatic polyesters including modified polyethylene terephtalates and modified polybutylene terephtalates; aliphatic/aromatic copolyesters; polycaprolactones; poly(3-hydroxyalkanoates) including poly(3-hydroxybutyrates), poly(3-hydroxyhexanoates), and poly(3-hydroxyvalerates); poly(3-hydroxyalkanoate) copolymers such as, for example, poly(hydroxybutyrate-co-hydroxyvalerate), poly(hydroxybutyrate-co-hexanoate) or other higher poly(hydroxybutyrate-co-alkanoates) as referenced in U.S. Pat. No. 5,498,692 to Noda, herein incorporated by reference; polyesters and polyurethanes derived from aliphatic polyols (i.e., dialkanoyl polymers); polyamides including polyethylene/vinyl alcohol copolymers; lactic acid polymers including lactic acid homopolymers and lactic acid copolymers; lactide polymers including lactide homopolymers and lactide copolymers; glycolide polymers including glycolide homopolymers and glycolide copolymers; and mixtures thereof. Preferred thermoplastic polymers suitable for use in multiconsitutent fibers include aliphatic polyesteramides, diacid/diol aliphatic polyesters, aliphatic/aromatic copolyesters, lactic acid polymers, and lactide polymers.

Spunbond structures, staple fibers, hollow fibers, shaped fibers, such as, for example, multi-lobal fibers and multicomponent fibers may all be produced by using the compositions and methods of the present invention. Multicomponent fibers, commonly bicomponent fibers, may be in a side-by-side, sheath-core, segmented pie, ribbon, or islands-in-the-sea configuration. The sheath may be continuous or non-continuous around the core. The ratio of the weight of the sheath to the core is from about 5:95 to about 95:5. The fibers of the present invention may have different geometries that include round, elliptical, star shaped, rectangular, and other various eccentricities. The fibers of the present invention may also be splittable fibers. Splitting may occur by rheological differences in the polymers or splitting may occur by a mechanical means and/or by fluid induced distortion.

For a bicomponent fiber, the ester condensate/polymer composition of the present invention may be both the sheath and the core with one of the components containing more ester condensate than the other component or small amount of polymer (e.g., less than about 5 wt. % polymer, based on the weight of the component). Alternatively, the ester condensate/polymer composition of the present invention may be the sheath with the core being ester condensate containing a small amount of polymer (e.g., less than about 5 wt. % polymer, based on the weight of the core). The ester condensate/polymer composition could also be the core with the sheath being ester condensate containing a small amount of polymer (e.g., less than about 5 wt. % polymer, based on the weight of the sheath). The exact configuration of the fiber desired is dependent upon the use of the fiber.

The fibers of the present invention may also be bonded or combined with other synthetic or natural fibers to make nonwoven articles. The synthetic or natural fibers (e.g., cellulosic fibers and derivatives thereof) may be blended together in the forming process or used in discrete layers. Suitable synthetic fibers include fibers made from polypropylene, polyethylene, polyester, polyacrylates, copolymers thereof, and mixtures thereof. Suitable cellulosic fibers include those derived from any tree or vegetation, including hardwood fibers, softwood fibers, hemp, and cotton. Also included are fibers made from processed natural cellulosic resources such as, for example, rayon.

The fibers described herein can be used to make disposable nonwoven materials for use in articles having a variety of different applications and uses. Some of these articles include disposable nonwovens for hygiene and medical applications, more specifically, for example, in applications such as, for example, diapers, wipes, feminine hygiene articles, drapes, gowns, sheeting, bandages and the like. In diapers, nonwoven materials are often employed in the top sheet or back sheet, and in feminine pads or products, nonwoven materials are often employed in the top sheet. Nonwoven articles generally contain greater than about 15% of a plurality of fibers that are continuous or non-continuous and physically and/or chemically attached to one another. The nonwoven may be combined with additional nonwovens or films to produce a layered product used either by itself or as a component in a complex combination of other materials. Nonwoven products produced from fibers can also exhibit desirable mechanical properties, particularly, strength, flexibility and softness. Measures of strength include dry and/or wet tensile strength. Flexibility is related to stiffness and can attribute to softness. Softness is generally described as a physiologically perceived attribute which is related to both flexibility and texture. Hygiene products produced from uncrosslinked alkyd oligomer fibers have superior fluid handling capability, compared to conventional thermoplastic fibers, due to the generally higher surface energy of the alkyd oligomer. One skilled in the art will appreciate that the fibers according to the invention are also suitable for use in applications other than nonwoven articles.

Notwithstanding the water stability of the fibers and other products produced in the present invention, the products may be environmentally degradable depending upon the amount of any additional polymer used, and the specific configuration of the product. The term “environmentally degradable” refers to the quality of being biodegradable, disintegratable, dispersible, flushable, compostable or a combination thereof. In the present invention, the fibers, nonwoven webs, and articles can be environmentally degradable.

In another aspect, the invention relates to a method for forming fibers made of uncross-linked alkyd oligomers. In this method, uncross-linked alkyd oligomers are liquefied to result in a melt. The melt undergoes pumping and spinning through a die, without inducing cross-linking, to form molten fibers. These molten fibers are then vitrified without inducing crosslinking.

The uncross-linked alkyd oligomer has a molecular weight of no more than 3000 g/mol, preferably no more than 2000 g/mol, more preferably no more than 1000 g/mol. Further, the alkyd oligomer has no more than 10 repeating units, preferably no more than 7 repeating units, more preferably no more than 5 repeating units (e.g., about 4 repeating units). The alkyd oligomers are uncross-linked and nonreactive and do not contain an amount of functional groups that can cause cross-linking by free radical addition chemistry (i.e. no more than 5% of carbon-carbon bonds are alkynes and/or alkenes).

The alkyd oligomer is formed by the condensation of polyols with an excipient selected from the group consisting of polyfunctional acids, anhydrides, and a mixture of polyfunctional acids and anhydrides. When the excipient is a polyfunctional acid, the molar ratio of total acid moieties on the polyfunctional acid to alcohol moieties on the polyol is as previously described herein. When the excipient is an anhydride, the molar ratio of total anhydride moieties on the anhydride to total alcohol moieties on the polyol is as previously described herein. The polyol preferably is a molecule that includes at least two alcohol moieties. Preferably, the alcohol moieites are primary hydroxyl groups. Nonlimiting examples of polyols are as previously described herein. The excipient is selected from the group consisting of a polyfunctional acid, an anhydride, and mixtures thereof. The polyfunctional acid preferably is a molecule that includes at least two carboxylic acid moieties. The anhydride preferably is a molecule that includes at least one anhydride moiety. Nonlimiting examples of the excipient are as previously described herein.

In some embodiments, the uncross-linked alkyd oligomer further includes a fatty acid, fat, oil (e.g., monoglycerides, diglycerides, triglycerides), or mixture thereof, as previously described herein. The fatty acid, fat, or oil can include up to about 80 wt. % of the oligomer, based on the total weight of the oligomer. In some embodiments, the fatty acid, fat or oil can include about 20 wt. % to about 40 wt. % of the oligomer, based on the total weight of the oligomer. In other embodiments, the fatty acid, fat or oil can include about 40 wt. % to about 60 wt. % of the oligomer, based on the total weight of the oligomer. In still other embodiments, the fatty acid, fat or oil can include about 60 wt. % to about 80 wt. % of the oligomer, based on the total weight of the oligomer. The higher the concentration of a fatty acid, fat, oil, or mixtures thereof results in softer, more sustainable fibers. Adjusting the amount of fatty acid, fat, oil, or mixtures thereof to tailor the properties of the resulting fiber will be understood by those skilled in the art.

The uncross-linked alkyd oligomers are liquefied by heating to result in a melt having a viscosity of about 0.1 kg m⁻¹ s⁻¹ to about 20 kg m⁻¹ s⁻¹, preferably about 0.5 kg m⁻¹ s⁻¹ to about 10 kg m⁻¹ s⁻¹, more preferably about 1 kg m⁻¹ s⁻¹ to about 5 kg m⁻¹ s⁻¹. Typically, the uncross-linked alkyd oligomers are liquefied by heating at a temperature of about 90° C. to about 230° C., preferably about 120° C. to about 210° C., more preferably about 150° C. to about 180° C. Heating the uncross-linked alkyd oligomers can occur by any means known in the art, such as, for example, a storage tank equipped with a heating element typically used in a hot melt adhesive system.

Spinning of the uncross-linked alkyd oligomer melt can be accomplished by any of the various methods used in conventional fiber spinning, including employing a high speed air jet to elongate the fiber-forming materials. Depending on the configuration of such spinning devices, fibers with normal diameters (e.g., 15 μm to 25 μm), as well as ultrafine, micro and nano fibers may be spun. Advantageously, fibers comprised of uncross-linked alkyd oligomers, unlike fibers comprised of conventional thermoplastics, can be formed using a simple spinnert without the aid of a high power extruder.

In general, fiber spinning rates include about 100 meters/minute to about 3,000 meters/minute, or about 300 meters/minute to about 2,000 meters/minute, or about 500 meters/minute to about 1,000 meters/minute. The spun fibers can be collected using any conventional method known in the art, such as, for example, with a collecting screen, conventional godet winding systems or through air drag attenuation devices. The fibers may be crimped and/or cut to form non-continuous fibers (staple fibers) used in a carding, airlaid, or fluidlaid process. Continuous fibers can be produced through, for example, spunbond methods or meltblowing processes. Alternately, non-continuous fibers (staple fibers) can be produced according to conventional staple fiber processes as are well known in the art. The various methods of fiber manufacturing can also be combined to produce a combination technique, as will be understood by those skilled in the art. Additionally, hollow core fibers as disclosed in U.S. Pat. No. 6,368,990 can be formed.

The die can have any equivalent diameter commonly used to make fibers. In some embodiments, the equivalent diameter of the die is less than about 1000 μm, less than about 900 μm, less than about 800 μm, less than about 700 μm, less than about 600 μm, less than about 500 μm, or less than about 400 μm. In other embodiments, the equivalent diameter of the die is about 100 μm to about 1000 μm, preferably about 200 μm to about 800 μm. As used herein, “equivalent diameter” is defined as four times the area of the cross-section of the die divided by its inner perimeter. For example, a die that has a cross-section in the shape of a circle and an inner diameter of 200 μm has an equivalent diameter of 200 μm. It is noted that other embodiments of the invention may employ dies having equivalent diameters as defined in Table 5-8 of PERRY'S CHEMICAL ENGINEERS' HANDBOOK, 5-25 (6th ed. 1984) (see also, 7th ed. 1997 at 6-12 to 6-13). For example, a die that has a cross-section in the shape of a rectangle with inner sides that are 200 μm and 150 μm in length has an equivalent diameter of four times (200×150)/[2(200+150)], or about 171.4 μm.

Vitrifying the molten fibers includes the physical reaction of cooling the molten fibers and does not involve crystallization or a chemical reaction (e.g., cross-linking). The temperature conditions for cooling depends on the specific process needs and will be apparent to one having ordinary skill in the art. In some embodiments, the molten fibers are cooled to room temperature. The molten fibers are cooled at a rate of at least 1000° C./second, and preferably faster than 10,000° C./second.

In some embodiments, an additive that functions as a processing aid or that affects the physical or mechanical properties of the fiber is optionally added to the uncross-linked alkyd oligomer melt before spinning. As previously described, the additive can affect the processing conditions of the fiber, its elasticity, tensile strength, modulus, oxidative stability, brightness, color, flexibility, resiliency, workability, odor control, or combinations thereof.

Examples of additives include polymers, lubricants, extenders, inorganic compounds (e.g., fillers, salts), modifiers of water responsiveness, accelerants for environmental degradation, antiblocking agents, slip agents, viscosity modifiers, antioxidants, colorants, plasticizers, odor masking agents, emulsifiers, surfactants, cyclodextrins, optical brighteners, flame retardants, dyes, pigments, fillers, proteins and their alkali salts, waxes, tackifying resins, as previously described herein, and any other processing aids or property modifiers used in the art, or combinations thereof.

The amount of additive present in the melt can be any amount conventionally used in the art. In some embodiments, the melt comprises less than about 50 wt. % of the additive, based on the total weight of the melt. Preferably, the melt comprises about 0.1 wt. % to about 20 wt. % of the additive, based on the total weight of the melt. More preferably, the melt comprises about 0.1 wt. % to about 12 wt. % of the additive, based on the total weight of the melt.

The process conditions used in the present invention are much more forgiving and flexible than the process conditions used to make conventional thermoplastic fibers, thermoset fibers, and cross-linked alkyd resin fibers because no chemical reaction is required to occur during fiber spinning. Therefore, much finer fibers can be made using a variety of different alkyd oligomers, such as, for example, soft alkyds that have a high concentration of oil. This freedom in the chemical composition of physical structure of the fiber can provide broader ranges of mechanical properties.

Ranges may be expressed herein as from “about” or “approximately” one particular value and/or to “about” or “approximately” another particular value. When such orange is expressed, another embodiment includes from the one particular value and/or to the other particular value. Similarly, when values are expressed as approximations, by use of the antecedent “about,” it will be understood that the particular value forms another embodiment.

### EXAMPLES

The following examples are provided to illustrate the invention, but are not intended to limit the scope thereof. The experiment described in Example 1 demonstrates the preparation of an uncross-linked alkyd oligomer. The experiment in Example 2 demonstrates the formation of a fiber comprised of uncross-linked alkyd oligomer.

### Example 1

### Preparation of Glycerol-Phthalate Oligomer

Glycerol (92.09 g, 1 mol) was added to a beaker and the beaker was placed on a plate situated under an overhead stirrer fitted with a 4-blade paddle mixing implement and a Brookfield viscometer. The mixing implement and viscometer was lowered into the glycerol and the sample was stirred with moderate heating. Phthalic anhydride (148.1 g, 1 mol) was slowly added to the stirring/warming glycerol. A thermocouple connected to a thermometer was inserted into the mixture to monitor the temperature, and the temperature of the solution was slowly raised to avoid overheating. The mixture became a clear, colorless solution around 125-130° C., and the temperature of the solution was then adjusted to 190° C. Some bubbling, which occurred quickly but at a moderate rate, was noticeable at this time. The solution continued to be stirred and heated at 190° C. until a desired viscosity was reached, generally 0.5 kg m⁻¹ s⁻¹ to 1 kg m⁻¹ s⁻¹. The solution was then cooled. The resulting material poured easily and was clear and slightly yellowish-red in color. Although the reaction can be concluded faster by raising the temperature. excess phthalic anhydride sublimation is likely to occur.

### Example 2

### Non-Reactive Fiber Production Using Glycerol-Phthalate Oligomer

The glycerol-phthalate oligomer from Example 1 was warmed to about 200° C. in a heated well of an ITW Dynatec Dynamelt hot melt adhesive supply unit. The now fluid oligomer was then pumped (mass flow 0.3%, 0.8-1.0 rpm) via a Dynatec 8′ heated hose (about 200° C.) to and through a heated melt blown die (about 200° C.) with a 500 μm opening. The alkyd oligomers were blown into fluid molten fibers via pressurized air (100 psi, 260° C.) also passing through the melt blown die. These molten fibers cooled rapidly and vitrified into solid fibers, which were drawn to and collected on a moving vacuum screen affixed to a rotating, oscillating drum for further processing or storage. The sole FIGURE is an image of the uncross-linked alkyd resin fibers taken with a scanning electron microscope. The fibers shown in the image are water-stable and have surprisingly small diameters (e.g., 10 μm to 20 μm) that allow the production of products with high opacity, flexibility, good fluid handling capacity, softness, and strength.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An article comprising a fiber having an equivalent diameter that is less than about 200 μm and a lengthwise dimension that is at least 20 times the equivalent diameter, the fiber comprising uncross-linked alkyd oligomers.

2. The article of claim 1, wherein the uncross-linked alkyd oligomers are nonreactive.

3. The article of claim 1, wherein the uncross-linked alkyd oligomers, when liquefied, have a viscosity of about 0.1 kg m⁻¹ s⁻¹ to about 20 kg m⁻¹ s⁻¹.

4. The article of claim 3, wherein the viscosity is about 0.5 kg m⁻¹ s⁻¹ to about 10 kg m⁻¹ s⁻¹.

5. The article of claim 4, wherein the viscosity is about 1 kg m⁻¹ s⁻¹ to about 5 kg m⁻¹ s⁻¹.

6. The article of claim 1, wherein the equivalent diameter is about 0.1 μm to about 30 μm.

7. The article of claim 1, wherein the fiber is substantially free of water

8. The article of claim 1, wherein the fiber further comprises a nonreactive additive.

9. The article of claim 8, wherein the additive is selected from the group consisting of polymers, surfactants, plasticizers, colorants, dyes, pigments, and mixtures thereof.

10. The article of claim 1, wherein the article is selected from the group consisting of diapers, wipes, feminine hygiene articles, drapes, gowns, sheeting, and bandages.

11. A method comprising:
(a) liquefying uncross-linked alkyd oligomers to result in a melt having a viscosity of about 0.1 kg m⁻¹ s⁻¹ to about 20 kg m⁻¹ s⁻¹;
(b) pumping and spinning the melt through a die having an effective diameter of less than about 1000 μm, without inducing cross-linking, to form molten fibers; and
(c) vitrifying the molten fibers without inducing cross-linking.

12. The method of claim 11, wherein the uncross-linked alkyd oligomers are nonreactive.

13. The method of claim 11, wherein liquefying comprises heating the uncross-linked alkyd oligomers to a temperature of about 90° C. to about 230° C.

14. The method of claim 12, wherein the temperature is about 120° C. to about 210° C.

15. The method of claim 11. wherein the viscosity is about 0.5 kg m⁻¹ s⁻¹ to about 10 kg m⁻¹ s⁻¹.

16. The method of claim 15, wherein the viscosity is about 1 kg m⁻¹ s⁻¹ to about 5 kg m⁻¹ s⁻¹.

17. The method of claim 11, wherein the effective diameter of the die is about 200 μm to about 800 μm.

18. The method of claim 11, comprising spinning the melt at a rate of less than about 3000 meters per minute.

19. The method of claim 11, wherein the melt further comprises a nonreactive additive.

20. The method of claim 19, wherein the additive is selected from the group consisting of polymers, surfactants, plasticizers, colorants, dyes, pigments, and mixtures thereof.
